(19) United States
(12) Patent Application Publication
(10) Pub. No.: US 2016/0156098 A1
(43) Pub. Date: Jun. 2, 2016

(54) WIRELESS COMMUNICATIONS MODULE

(71) Applicant: SAMSUNG ELECTRO-MECHANICS CO., LTD., Suwon-Si (KR)

(72) Inventor: Hyo Jin KIM, Suwon-Si (KR)

(73) Assignee: SAMSUNG ELECTRO-MECHANICS CO., LTD., Suwon-Si (KR)

(21) Appl. No.: 14/947,264

(22) Filed: Nov. 20, 2015

(30) Foreign Application Priority Data
Dec. 2, 2014 (KR) 10-2014-0170632

(51) Int. Cl. H01Q 1/52; H01Q 1/48

(52) U.S. Cl. CPC H01Q 1/526; H01Q 1/48

(57) ABSTRACT

A wireless communications module, including a module substrate, wherein a plurality of elements, a ground pattern, and a conduction pattern are disposed on a surface of the module substrate. A shield integrated antenna is disposed on the surface of the module substrate, wherein the shield integrated antenna includes a shield part enclosing at least one element of the plurality of elements; a ground part extending from a side surface of the shield part and electrically connected to the ground pattern; and an antenna part extending from the ground part and electrically connected to the conduction pattern.

### CROSS-REFERENCE TO RELATED APPLICATION

This application claims the benefit under 35 USC 119(a) of Korean Patent Application No. 10-2014-0170632 filed on Dec. 2, 2014, in the Korean Intellectual Property Office, the disclosure of which is incorporated herein by reference for all purposes.

### BACKGROUND

1. Field

The following description relates to a wireless communications module.

2. Description of Related Art

With the development of wireless communications technology, various portable electronic devices support wireless communications. Therefore, to perform wireless communications, electronic devices have included wireless communications modules.

A wireless communications module may include a module substrate on which various elements required for wireless communications are mounted. Further, a shield may cover and protect the elements, and an antenna for wireless communications may also be mounted on the module substrate.

Various kinds of components including an integrated device are mounted on an upper surface of the module substrate, and the shield covers the components. Further, the antenna is mounted on a conductive pattern of the module substrate.

In the related art, however, the shield and the antenna are required to be separately mounted on the module substrate. Therefore, a separate process is required to fix the antenna to the module substrate. Further, the antenna and the shield are relatively large components, and therefore, there is a need to prevent mutual interference between the two components. As a result, constraints on design or the like may occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless communications module is capable of improving reliability and process efficiency using a shield integrated antenna. The wireless communications module includes a module substrate, wherein a plurality of elements, a ground pattern, and a conduction pattern are disposed on a surface of the module substrate. A shield integrated antenna is disposed on the surface of the module substrate, wherein the shield integrated antenna includes a shield part enclosing at least one element of the plurality of elements; a ground part extending from a side surface of the shield part and electrically connected to the ground pattern; and an antenna part extending from the ground part and electrically connected to the conduction pattern.

In another general aspect, a wireless communications module includes a module substrate including a surface, a plurality of elements disposed on the surface, and first and second ground patterns and first and second conduction patterns disposed on the surface. A shield integrated antenna, disposed on the surface, includes a shield part accommodating one element of the plurality of elements, first and second ground nodes extending from a side surface of the shield part contacting the first and second ground patterns, respectively, in order to electrically ground the shield part. A first antenna extending from the first ground node includes a first conduction node contacting the first conduction pattern, and a second antenna extending from the second ground node includes a second conduction node contacting the second conduction pattern.

Other features and aspects will be apparent from the following detailed description, the drawings, and the claims.

### BRIEF DESCRIPTION OF DRAWINGS

FIG. 1 is a plan view illustrating an example of a wireless communications module;

FIG. 2 is a perspective view illustrating an example of a wireless communications module;

FIG. 3 is an exploded perspective view illustrating an example of a wireless communications module;

FIG. 4 is a perspective view of an example of a shield integrated antenna viewed in a first direction; and

FIG. 5 is a perspective view of an example of a shield integrated antenna viewed in a second direction.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

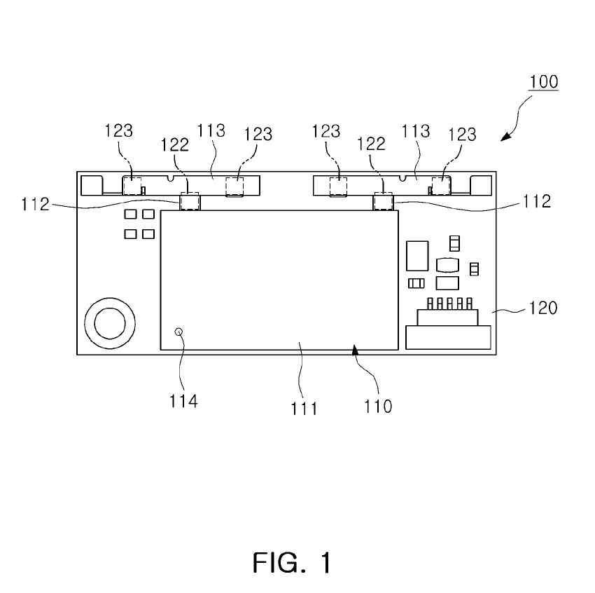

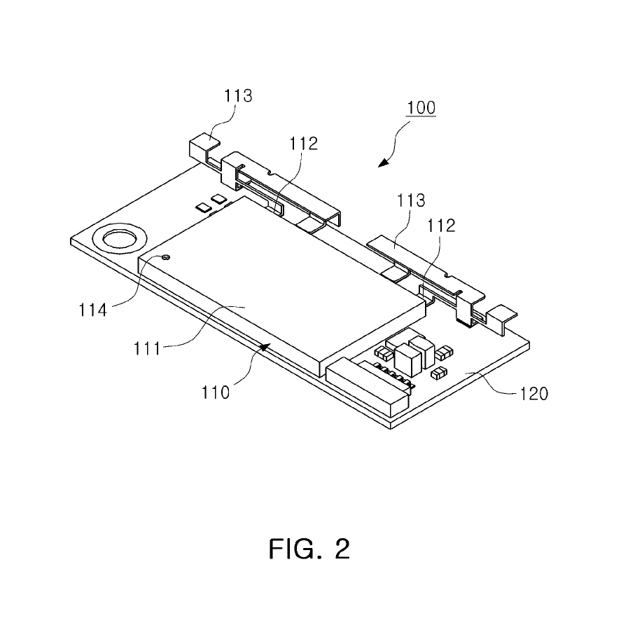

Referring to FIGS. 1 and 2, a wireless communications module 100 includes a module substrate 120 and a shield integrated antenna 110. The module substrate 120 includes one surface on which a plurality of elements 121 are mounted. The elements 121 are electronic components, electronic elements, or electronic circuit elements.

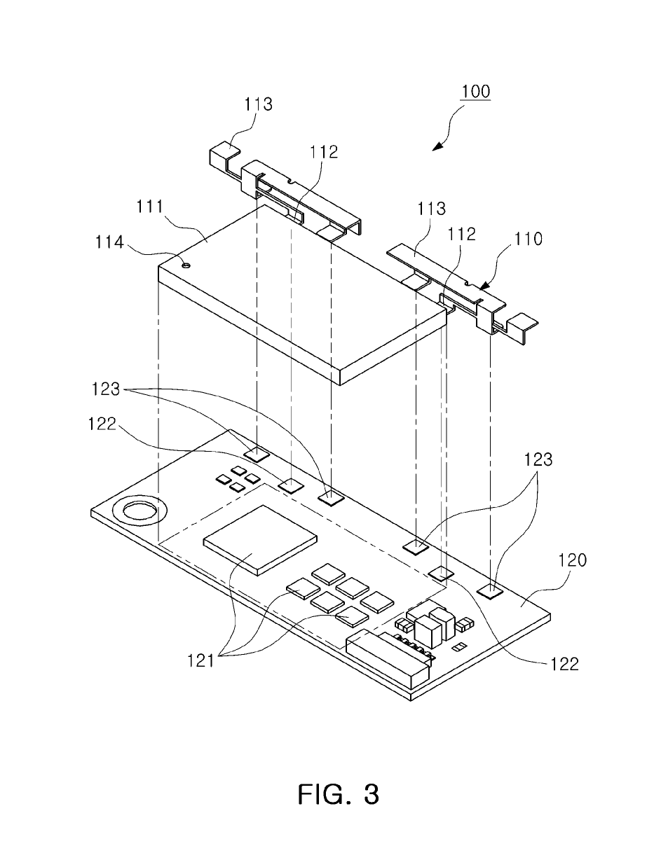

As shown in FIG. 3, some elements are mounted outside of a shield, and the rest of the elements 121 are mounted within the shield. Conduction lines (not shown) may be disposed inside, outside, or on the surface of the module substrate 120, and the module substrate 120 includes a conduction pattern 123 connected to the conduction lines and a ground pattern 122.

The shield integrated antenna 110 is mounted on one surface of the module substrate 120. The shield integrated antenna 110 includes the shield and the antenna and is formed by integrating the shield and the antenna. Therefore, when one of the shield and the antenna is fixed or bonded to the module substrate 120, the other of the shield and the antenna accordingly contacts, and is fixed to, the module substrate 120.

For example, the shield integrated antenna 110 includes a shield part 111, an antenna part 113, and a ground part 112. The ground part 112 connects the shield part 111 to the antenna part 113 and contacts the ground pattern 122 to electrically ground the shield part 111 and the antenna part 113. The shield integrated antenna 110 contacts the first and second ground patterns 122 and the first and second conduction patterns 123 to electrically connect the integrated shield antenna 110 to the first and second ground patterns 122 and the first and second conduction patterns 123.

The shield part 111 includes a polygonal upper surface and a plurality of side surfaces extending downwardly from edges of the polygonal upper surface. Examples shown in FIGS. 1, 2 and 5 show a hexahedron which has an open base surface and side surfaces bent downwardly, extending from respective edges of a rectangular upper surface. However, the shield part 111 may be formed in various polyhedrons. The shield part 111 may accommodate at least one of the plurality of elements 121 on the module substrate 120.

The shield part 111 includes a through hole 114. For example, an insulating material is provided between the shield part 111 and one surface of the insulating substrate 120 to fix the shield part 111 to the module substrate 120. An underfill or sidefill scheme may be used to apply the insulating material. The through hole 114 discharges gases present in the shield part 111 when the insulating material is provided.

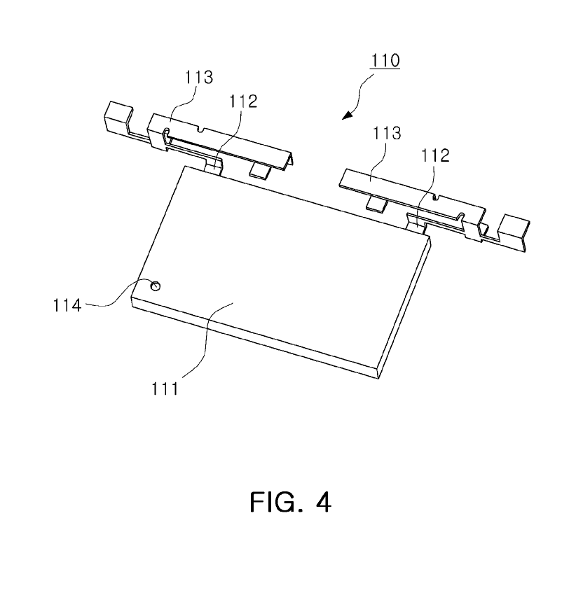

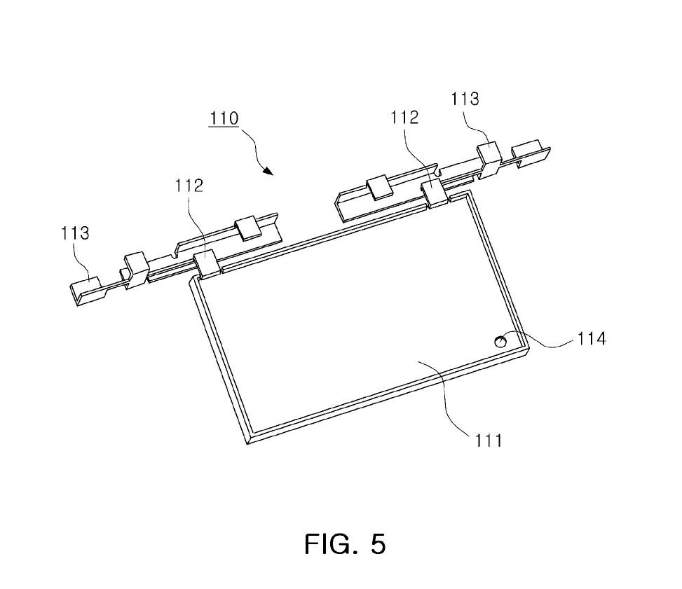

Referring to FIGS. 4 and 5, the ground part 112 extends from a bottom edge of a side surface of the shield part 111 and is electrically connected to the ground pattern 122 of the module substrate 120. The ground part 112 is electrically grounded and also allows the shield part 111 to be electrically grounded. The antenna part 113 extends from the ground part 112 and is electrically connected to the conduction pattern 123.

Hereinafter, a coupled structure of the shield integrated antenna 110 with the module substrate 120 will be described in more detail with reference to FIG. 3.

Referring to FIG. 3, the module substrate 120 includes conduction lines provided inside or outside and includes the conduction pattern 123 connected to the conduction lines and the ground pattern 122. The conduction pattern 123 is connected to the conduction lines to thereby electrically connect the antenna to the elements 121. The ground pattern 122 is electrically grounded and electrically connected to other ground patterns or to other ground terminals through the conduction lines. The conduction pattern 123 and the ground pattern 122 are formed on the same surface of the module substrate 120. The shield integrated antenna 110 is fixed to one surface of the module substrate 120 and therefore the conduction pattern 123 and the ground pattern 122 are formed on the surface of the module substrate 120 to which the shield integrated antenna 110 is fixed.

The shield part 111 covers the conduction pattern 123 of the module substrate 120 to protect the conduction pattern 123. The ground part 112 extends from a bottom edge of a side surface of the shield part 111. The ground part 112 contacts the ground pattern 122 of the module substrate 120 to be electrically connected thereto. The shield part 111 is grounded by the ground part 112. The ground part 112 may extend as a bent member from the bottom edge of the side surface of the shield part 111. When the ground pattern 122 has a predetermined thickness, a height at which the ground part 112 is bent externally from the shield part 111 is determined by the predetermined thickness. In other words, the amount of ground part 112 is bent from the shield part 111 is determined by the amount the ground pattern 122 protrudes from the module substrate 120.

The ground part 112 is formed from a same conductive material as that of the shield part 111 in order to electrically grounds he shield part 111. The antenna part 113 extends from the ground part 112. The antenna part 113 is electrically connected to the conduction pattern 123. The antenna part 113 is electrically connected to the elements 121 through the conduction pattern 123.

The antenna part 113 may include an inverted F antenna bent upwardly from the ground part 112. At least a portion of the inverted F antenna is in parallel with the ground part 112. That is, a portion of the antenna part 113 contacts the conduction pattern 123. Thus, a portion of the antenna part 113 is formed on a same plane on which the ground part 112 is disposed.

Hereinafter, the shield integrated antenna 110 will be described in more detail with reference to FIGS. 4 and 5. The shield integrated antenna 110 includes the shield part 111, the ground part 112, and the antenna part 113. A pair of antennas are provided and a pair of ground parts. The ground part 112 includes a first ground node extending from the bottom edge of the side surface of the shield part 111 and a second ground node extending from the bottom edge of the side surface of the shield part 111 and disposed in parallel with the first ground node. The first and second ground nodes 112 contact the first and second conduction patterns, respectively. The node is defined as an area directly contacting the pattern of the module substrate.

The node is electrically connected to the pattern of the module substrate through direct contact. Therefore, when a portion of the shield integrated antenna 110 is fixed to the module substrate, the node accordingly contacts the pattern of the module substrate and creates an electrical connection thereto.

The antenna part 113 includes a first antenna and a second antenna. The first antenna extends from the first ground node and disposed in parallel with one side surface of the shield part 111. The second antenna extends from the second ground node and disposed in parallel with one side surface of the shield part while opposing the first antenna.

The first and second antennas include first and second conduction nodes 113, respectively, formed on the same plane as the ground node 112. In this configuration, the first and second conduction nodes contact the first and second conduction patterns, respectively, provided on one surface of the module substrate. Therefore, the first and second conduction nodes are electrically connected to the first and second conduction patterns, respectively.

The shield part 111 is formed of a conductive material which is the same as that of the first and second ground nodes 112 and the first and second antennas 113.

As set forth above, the wireless communications module is capable of improving reliability and process efficiency by integrating the shield and the antenna may be provided. The antenna contacts the conduction pattern of the module substrate by fixing the shield to the module substrate, without fixing the antenna to the module substrate, thereby improving reliability and process efficiency. While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless communications module, comprising:
a module substrate, wherein a plurality of elements, a ground pattern, and a conduction pattern are disposed on a surface of the module substrate; and
a shield integrated antenna disposed on the surface of the module substrate,
wherein the shield integrated antenna comprises:
a shield part enclosing one element of the plurality of elements;
a ground part extending from a side surface of the shield part and electrically connected to the ground pattern; and
an antenna part extending from the ground part and electrically connected to the conduction pattern.

2. The wireless communications module of claim 1, wherein the shield part comprises:
an upper surface; and
a plurality of side surfaces extending perpendicularly from respective edges of the upper surface.

3. The wireless communications module of claim 2, wherein the shield part further comprises a through hole disposed in the upper surface, and
an insulating material disposed between the shield part and the surface of the module substrate.

4. The wireless communications module of claim 1, wherein the shield part is electrically grounded.

5. The wireless communications module of claim 2, wherein the ground part extends perpendicularly from a bottom edge of one side surface of the plurality of side surfaces.

6. The wireless communications module of claim 5, wherein the ground part contacts the ground pattern disposed on the module substrate.

7. The wireless communications module of claim 5, wherein the ground part and the shield part are formed of a same conductive material in order to electrically ground the shield part.

8. The wireless communications module of claim 5, wherein the antenna part comprises an inverted F antenna extending from the ground part.

9. The wireless communications module of claim 8, wherein a portion of the inverted F antenna is in parallel with the ground part.

10. The wireless communications module of claim 9, wherein the a portion of the inverted F antenna contacts the conduction pattern.

11. The wireless communications module of claim 1, wherein the ground part comprises:
a first ground node extending from the side surface of the shield part; and
a second ground node extending from the side surface of the shield part and disposed in parallel with the first ground node.

12. The wireless communications module of claim 11, wherein the antenna part comprises:
a first antenna extending from the first ground node in parallel with the side surface of the shield part; and
a second antenna extending from the second ground node in parallel with the side surface of the shield part while opposing the first antenna.

13. The wireless communications module of claim 12, wherein the first and second antennas comprise first and second conduction nodes, respectively, and
the first and second conduction nodes and the first and second ground nodes are disposed on a same plane.

14. The wireless communications module of claim 13, wherein the first and second conduction nodes contact first and second conduction patterns provided on the surface of the module substrate.

15. A wireless communications module, comprising:
a module substrate comprising:
a surface;
a plurality of elements disposed on the surface; and
first and second ground patterns and first and second conduction patterns disposed on the surface; and
a shield integrated antenna disposed on the surface,
wherein the shield integrated antenna comprises:
a shield part accommodating one element of the plurality of elements,
first and second ground nodes, extending from a side surface of the shield part, contacting the first and second ground patterns, respectively, in order to electrically ground the shield part,
a first antenna extending from the first ground node comprising a first conduction node contacting the first conduction pattern, and
a second antenna extending from the second ground node comprising a second conduction node contacting the second conduction pattern.

16. The wireless communications module of claim 15, wherein the shield part is formed of a same conductive material as the first and second ground nodes and the first and second antennas, and
wherein the shield integrated antenna contacts the first and second ground patterns and the first and second conduction patterns.
